(19) United States
(12) Patent Application Publication
(10) Pub. No.: US 2008/0198984 A1
(43) Pub. Date: Aug. 21, 2008

(54) Method of producing an item for conveying an audio greeting

(76) Inventors: Alexander James Green, Newbury (GB); Samuel Edward Anthony Green, Hungerford (GB)

Correspondence Address: JAMES C. WRAY, 1493 CHAIN BRIDGE ROAD, SUITE 300, MCLEAN, VA, 22101, US

(21) Appl. No.: 12/069,956

(22) Filed: Feb. 14, 2008

(30) Foreign Application Priority Data
Feb. 15, 2007 (GB) 07 02 906.9

(51) Int. Cl. H04M 3/50

(52) U.S. Cl. 379/88.23

(57) ABSTRACT

An item for conveying an audio greeting is produced. A request is received for dispatching an item to a recipient, an audio greeting is received, the audio greeting is downloaded to the item as a digital file and the item is dispatched to the recipient.

### TECHNICAL FIELD

The present invention relates to a method of producing an item for conveying an audio greeting.

### BACKGROUND OF THE INVENTION

Many occasions exist for which it is desirable to convey a greeting. Greetings often take the form of cards, and some cards are available containing audio devices with messages, but there is very little choice available.

### BRIEF SUMMARY OF THE INVENTION

According to a first aspect of the present invention, there is provided a method of producing an item for conveying an audio greeting comprising the steps of receiving a request for dispatching an item to a recipient, receiving an audio greeting via a telephone connection, requiring a pass code to be submitted via said telephone connection; checking that the correct pass code has been submitted before receiving said audio greeting via said telephone connection downloading said audio greeting to said item, and dispatching said item to said recipient.

According to a second aspect of the present invention, there is provided a method of producing an item for conveying an audio greeting comprising the steps of receiving a request for dispatching an item to a recipient, receiving an indication as to whether a pre-recorded or new audio greeting is required, if a pre-recorded greeting is required receiving a selection from a set of pre-recorded greetings and if a new audio greeting is required receiving an audio greeting, downloading said audio greeting to said item, and dispatching said item to said recipient

According to a third aspect of the invention there is provided apparatus for producing an item for conveying an audio greeting, comprising storage, memory, a processor and a network connection, wherein said processor is configured to perform the steps of receiving a request via -said network connection for dispatching an item to a recipient, receiving an audio greeting, downloading said audio greeting to said item, and dispatching said item to said recipient.

### BRIEF DESCRIPTION OF THE SEVERAL VIEWS OF THE DRAWINGS

FIG. 1 shows an example of an item produced by a method according to the present invention;

FIG. 2 shows a processing system suitable for use in the present invention;

FIG. 3 shows an overview of an embodiment of the present invention;

FIG. 4 shows a screen displayed to a user at step 301;

FIG. 5 shows an example of the screen displayed to a user at step 303;

FIG. 6 shows an expansion of step 304;

FIG. 7 illustrates an example of a screen displayed at step 304;

FIG. 8 shows an example of the screen displayed at step 602;

FIG. 9 shows interactions within the system as a result of selection of the option to add a pre-recorded greeting;

FIG. 10 shows an example of information displayed at step 605;

FIG. 11 shows interactions within the system as a result of selection of the option to obtain the audio greeting from a file;

FIG. 12 shows an expansion of step 607;

FIG. 13 illustrates an example of the screen displayed at step 1201;

FIG. 14 shows interactions within the system as a result of selection of the option to record a greeting with a microphone;

FIG. 15 shows an expansion of step 609;

FIG. 16 shows an example of information displayed at step 1501;

FIG. 17 shows an example of procedures occurring at step 1503;

FIG. 18 shows interactions within the system as a result of selection of the option to record an audio greeting over a telephone connection;

FIG. 19 illustrates card 101 being prepared for dispatch; and

FIG. 20 shows an example of a collection of cards ready for dispatch

### DESCRIPTION OF THE BEST MODE FOR CARRYING OUT THE INVENTION

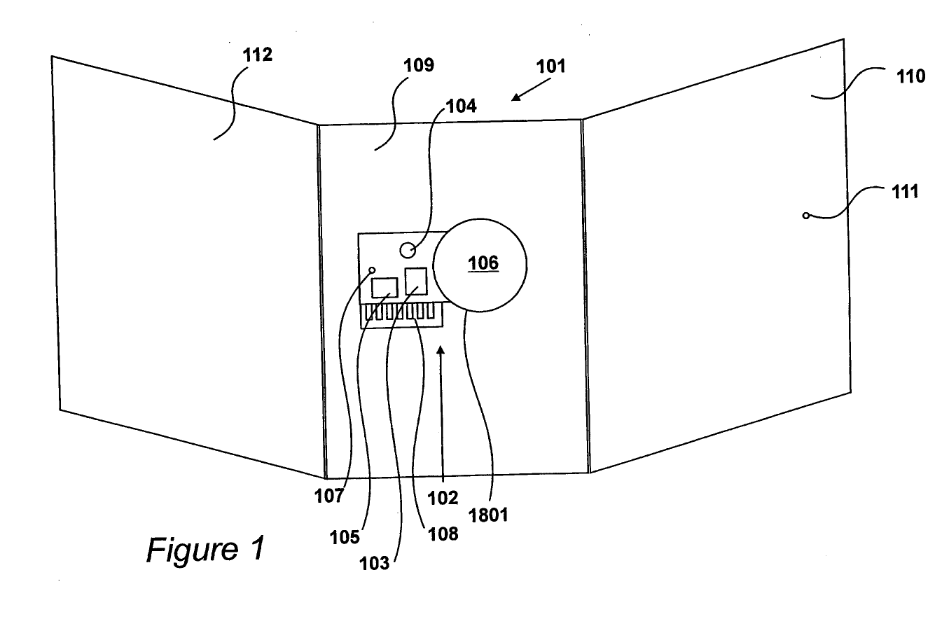

### FIG. 1

An example of an item produced by a method according to the present invention is shown in FIG. 1. In this example the item is greetings card 101. Greetings card 101 is a card with a fold and a greeting printed on the front and/or on the inside. Alternatively, the item could be a postcard, letter, or any other item capable of conveying an audio greeting. An audio greeting is for example a spoken message, a song or a poem etc.

Greetings card 101 includes module 102, and in other examples any audio playback device can be used. Module 102 includes memory 103, a battery 104, a processor 105, a speaker 106 and a light sensor 107. A light sensor is used to actuate the module in this example, but alternatively a mechanical actuator could be provided. The actuator serves to initiate play of the audio greeting upon opening of the card. There is also provided a socket 108 that allows an external source to connect to module 102 in order to download audio to it. Socket 108 comprises a seven or eight prong attachment to plug a lead into and copper teeth are provided. In this embodiment, module 102 includes a fixed circuit and has one time programmable (OTP) memory. In alternative embodiments the module may include re-recordable memory.

Module 102 is attached to centre portion 109 of greetings card 101. A first flap 110 is provided which folds onto centre portion 109 and is secured in position, concealing module 102. In this example a hole 111 is provided which, when folded over, lines up with light sensor 107. A further flap 112 forms the front of the card.

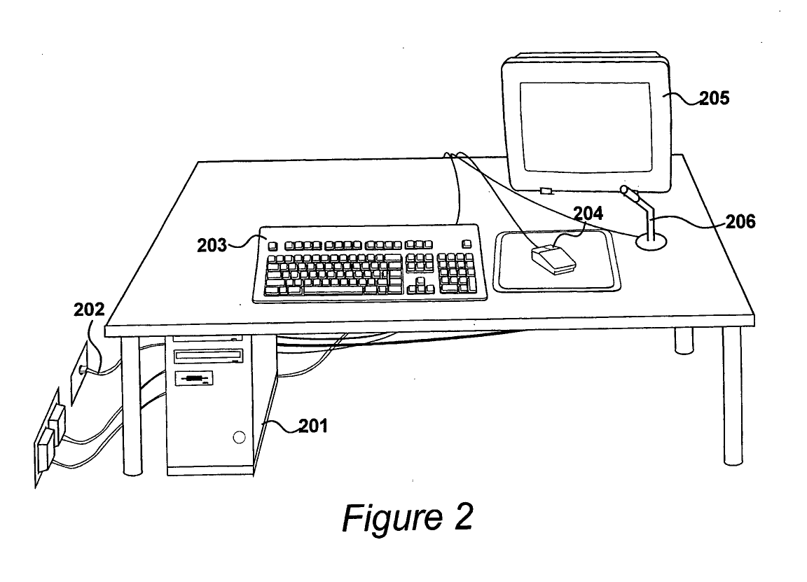

### FIG. 2

A computer suitable for use in an embodiment of the present invention is shown in FIG. 2. A processing system 201 is provided which is connected to a wide area network (WAN) such as the Internet via network connection 202. Keyboard 203 and mouse 204 receive user input. Monitor 205 is provided to display information to a user. A microphone 206 is also provided that may be used to capture an audio greeting. It should be appreciated that the computer shown in FIG. 2 is an example of suitable equipment and that any computer capable of providing navigation to a web-site and means for input could be used.

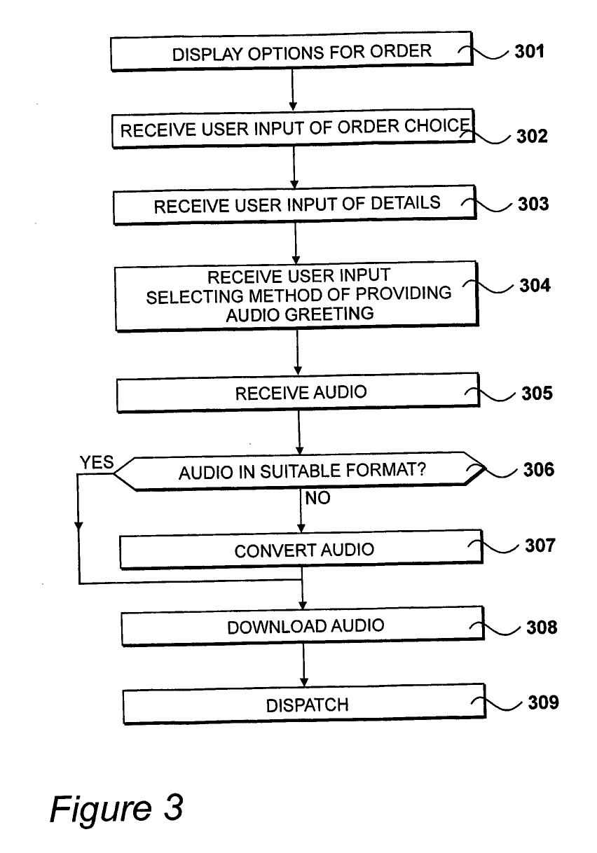

### FIG. 3

An overview of an embodiment of the present invention is shown in FIG. 3. Procedures begin when a user navigates with an internet browser to a web-site provided by a server system that is configured to receive a request for dispatching an item to a recipient. A request is received from a user by input means. An internet browser is any program which allows a user to view and interact with web-sites. In alternative embodiments the entire procedure may be conducted by telephone or any other means suitable for receiving a request for dispatching an item to a recipient.

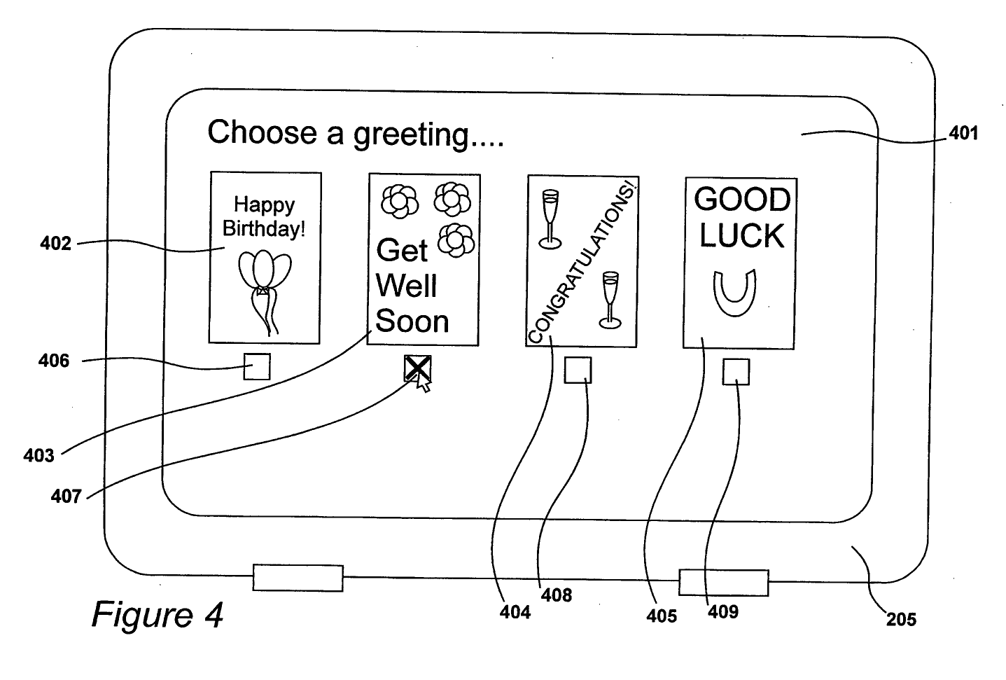

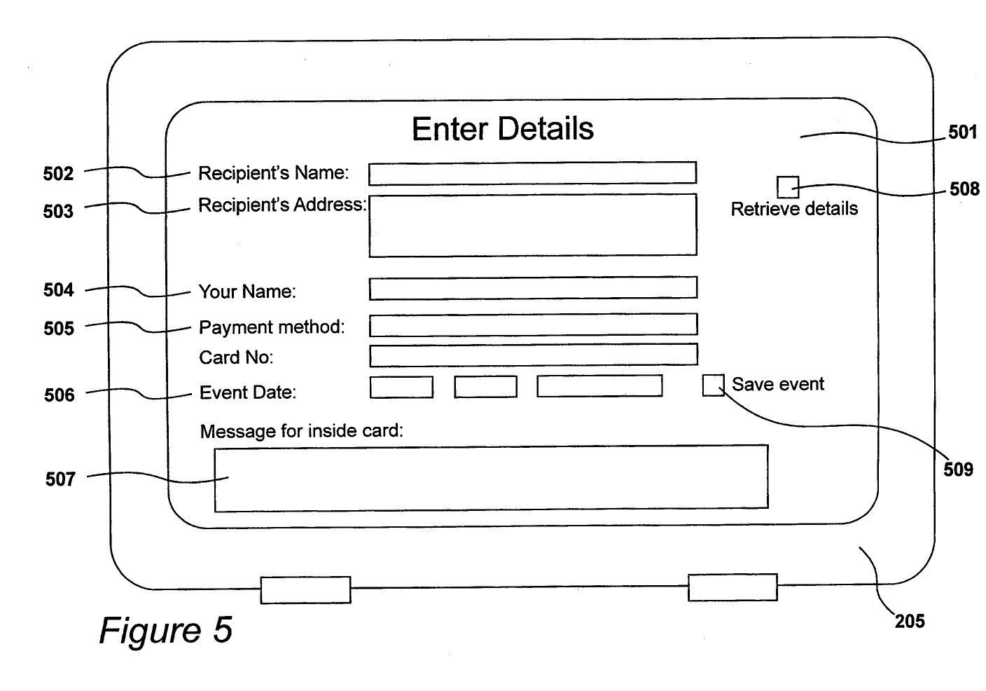

At step 301 a series of options are displayed to a user from a web-site on monitor 205. An example of this is shown in FIG. 4. At step 302 user input is received indicating order choice. At step 303 the server system receives user input of their details. This is illustrated in FIG. 5.

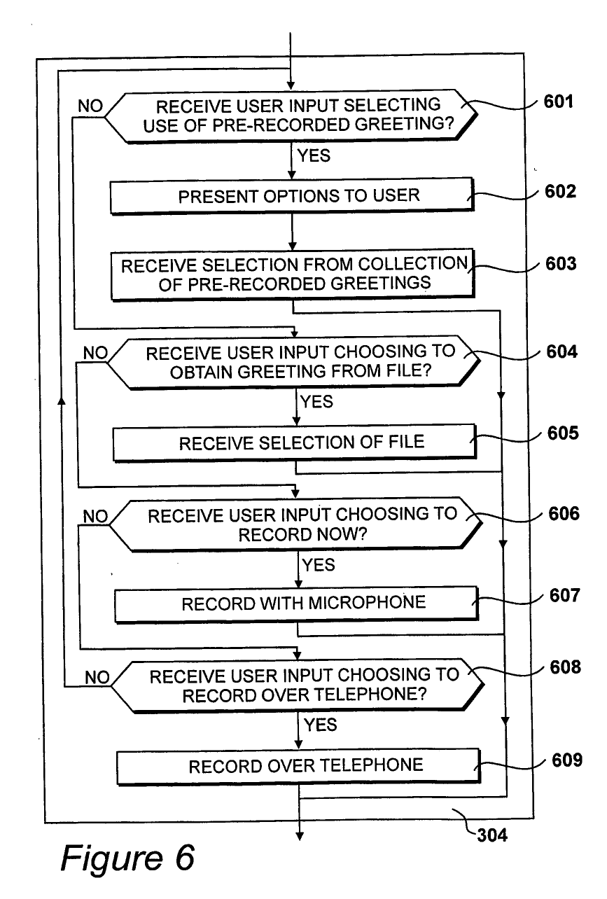

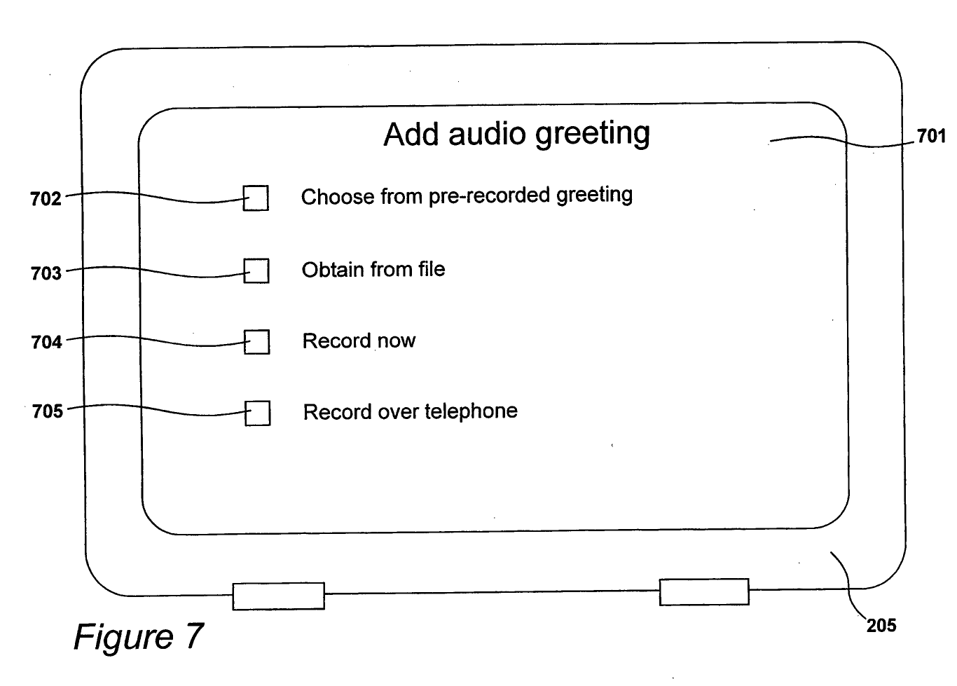

At step 304, user input is received by the server system selecting a method of providing an audio greeting. This step is expanded upon in FIG. 6 and illustrated by example in FIG. 7.

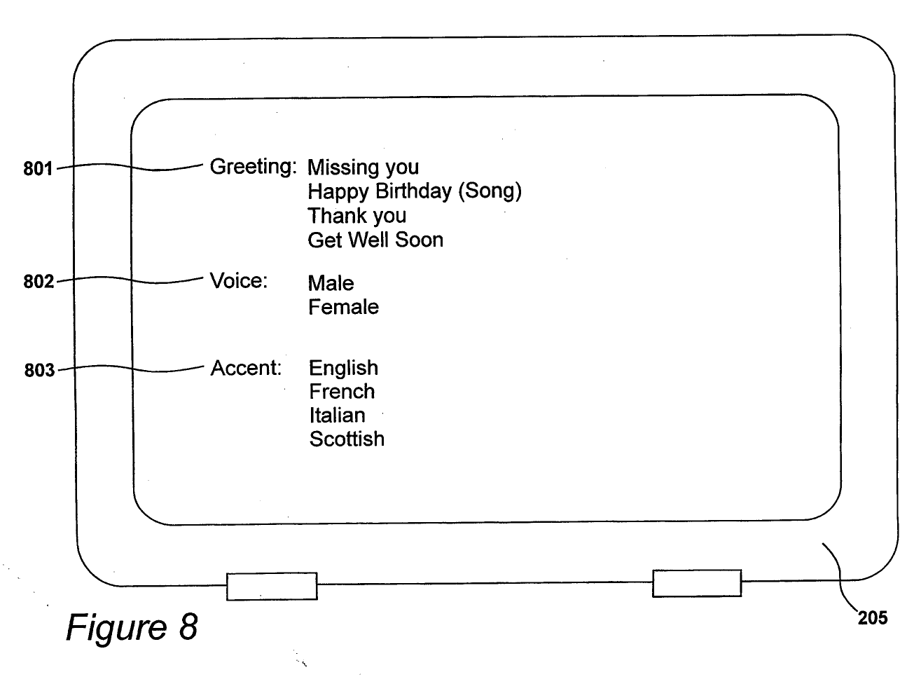

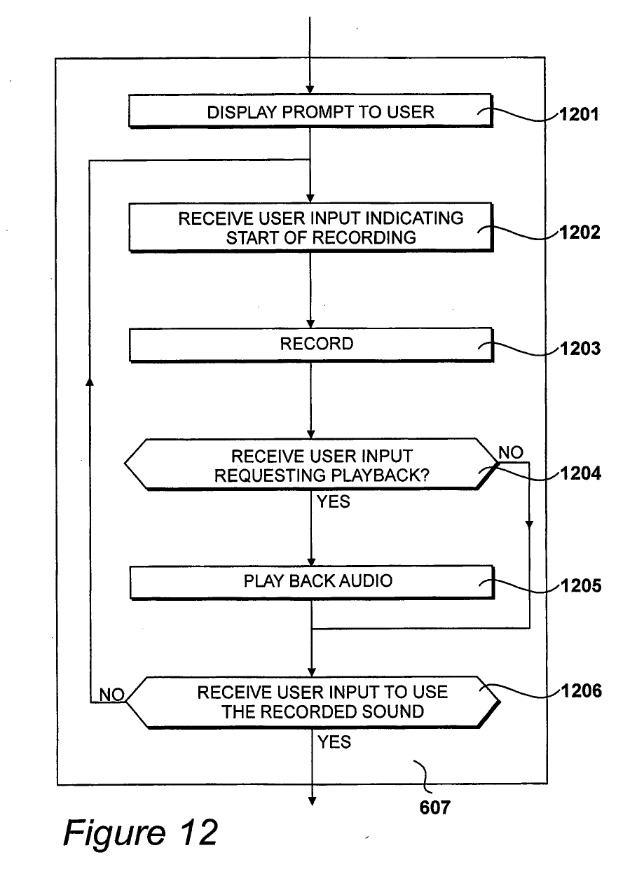

At step 305 an audio greeting is received by the server system. The audio has either been selected from a pre-recorded source as described with reference to FIGS. 8, 9, 10 and 11 or captured as described with reference to FIGS. 12, 13, 14, 15, 16, 17 and 18.

At step 306, a question is asked as to whether or not the audio received is in a suitable format. If the initial format in which the audio is received is suitable for downloading to module 102 then this question is answered in the affirmative. Step 307 is then omitted and control passes to 308. If the question asked at step 306 is answered in the negative such that the initial format is not suitable then the audio is converted into a transfer format at step 307. The conversion takes place on the server system. In alternative embodiments conversion may take place on computer 201 before audio is received by the server system. The conversation may, for example, take the form of analog data being converted to digital data or digital data being converted to analog data. Other conversions between formats are also possible.

At step 308 the audio greeting is downloaded to the module 102. The step of downloading is transferring an audio greeting onto the module 102 such that it is then stored on its memory 103 in storage format. In alternative embodiments this may be done wirelessly. In alternative embodiments the initial format, transfer format and storage format may all be the same. In this example an audio greeting is downloaded onto module 102 before it is attached to greetings card 101.

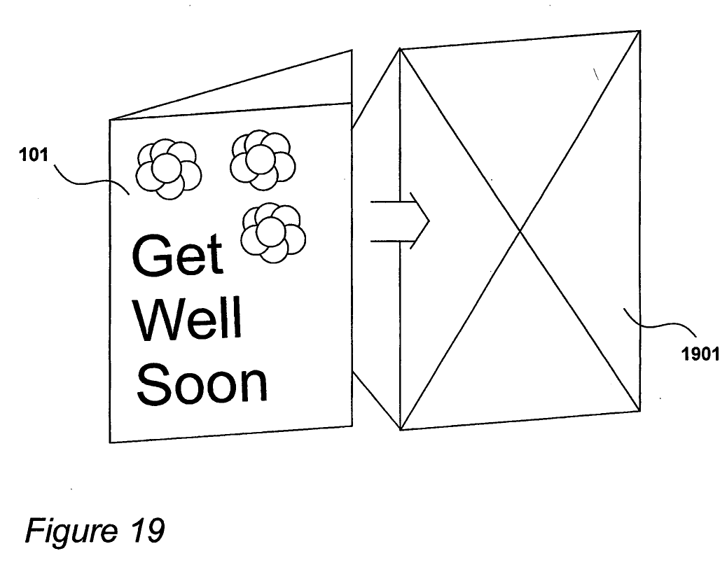

In the present embodiment, analog data is downloaded onto module 102, for example by using the line out socket from a soundcard on the server system. Module 102 then stores the data in a digital storage format. In alternative embodiments different storage formats could be used. This procedure is further described with reference to FIG. 19.

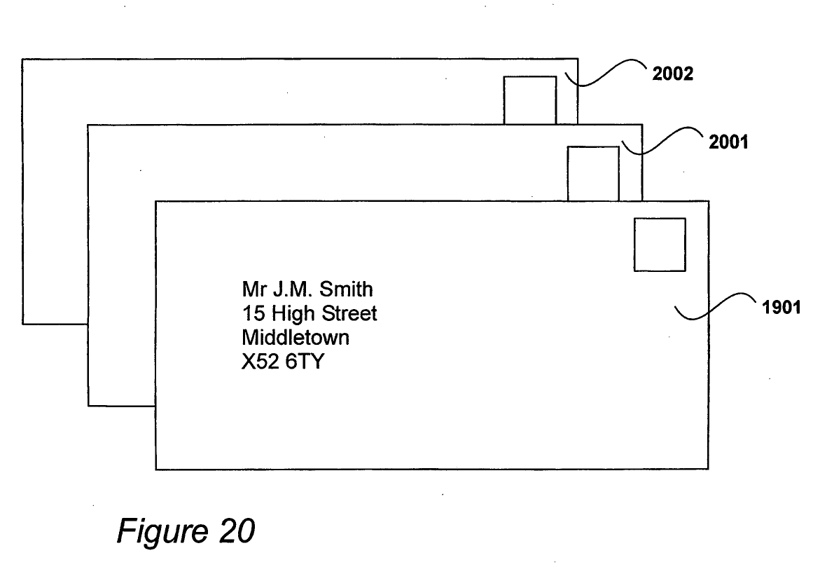

At step 309 the item is dispatched. This is further described with reference to FIG. 20.

### FIG. 4

An example of a screen displayed to a user at step 301 is shown in FIG. 4. Monitor 205 is shown displaying screen 401 which provides options of greetings from which a user is able to choose. In this example a first greeting “Happy Birthday” is provided at 402, a second greeting “Get Well Soon” is provided at 403, a third greeting “Congratulations” is provided at 404 and a fourth greeting “Good Luck” is provided at 405. Each greeting has its own respective tick box. Box 406 relates to greeting 402, box 407 relates to greeting 403, box 408 relates to greeting 404 and box 409 relates to greeting 405. A user is therefore able to move a cursor to tick the respective tick box of the greeting they wish to choose. In this example the greeting 403 “Get Well Soon” is selected.

### FIG. 5

An example of a screen displayed at step 303 for a user to input their details is shown in FIG. 5. Monitor 205 is seen displaying screen 501 which requests various details from a user including the name of the recipient at 502, the address of the recipient 503 and the name of the person ordering at 504. Space is also provided for payment details at 505, the event date can be entered at 506 and a message to be printed inside the card can be entered at 507. All of the fields contain boxes into which a user can type using keyboard 103 in order to enter details.

An shortcut option is shown at 508 which allows a user to retrieve their details. This allows a user to set up an account and enter their own details on the first occasion, and retrieve them from the server system on subsequent occasions such that their own name, address etc and payment details need not be entered repeatedly.

At 509 a shortcut option is provided to save the event. This provides a service whereby a series of important events are recorded such as birthdays of family members or friends and the server system can provide reminders, by email for example, on appropriate dates. Such reminders may contain a link to the web-site provided by the server system as shown in FIG. 4 from which a greetings card can be ordered.

Entering the event date at 506 enables the greeting to be dispatched such that it reaches its destination at an appropriate time. A message entered at 507 is printed inside the card and can be personalised according to a user's requirements. In further embodiments some of the fields shown in FIG. 5 may not be present. Alternatively there may be further details required or further shortcut options available.

### FIG. 6

An expansion of step 304 shown in FIG. 3 is provided in FIG. 6. At this step user input is received selecting a method of providing an audio greeting.

At step 601 a question is asked as to whether user input has been received selecting the use of a pre-recorded greeting. If this question is answered in the affirmative then a series of options are presented to a user at step 602. An example of this is shown in FIG. 8. User input is received selecting an audio greeting from a collection of pre-recorded greetings at step 603. Step 304 is thus concluded.

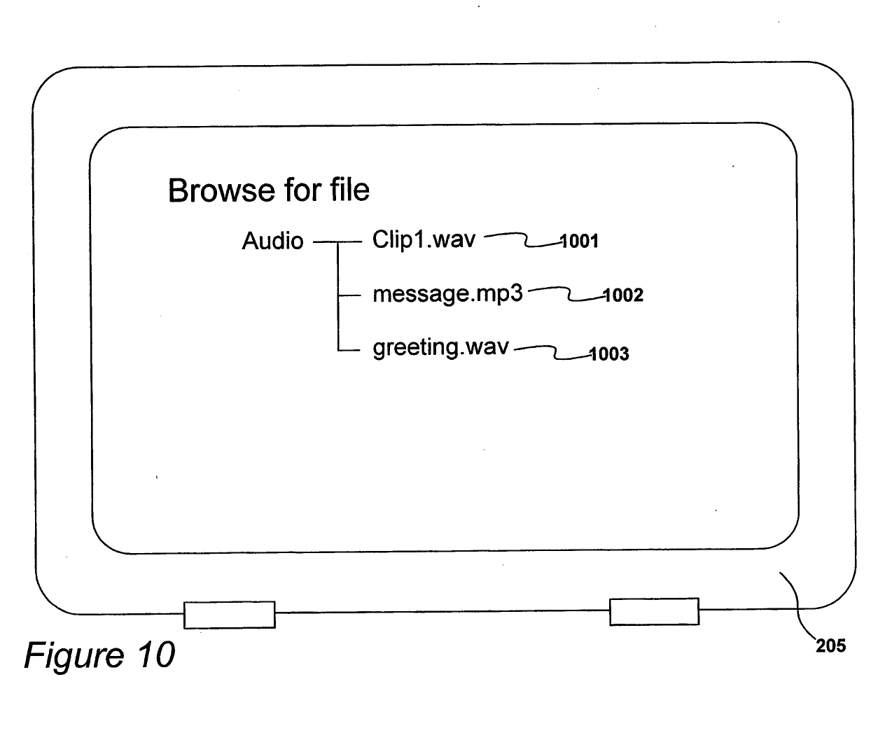

If the question asked at step 601 is answered in the negative indicating that user input has not been received selecting use of a pre-recorded greeting then control passes to step 604. At step 604 a question is asked as to whether user input has been received choosing to obtain a greeting from a file. If this question is answered in the affirmative then input is received indicating selection of a file at step 605. An example of this is shown in FIG. 10.Step 304 is then finished.

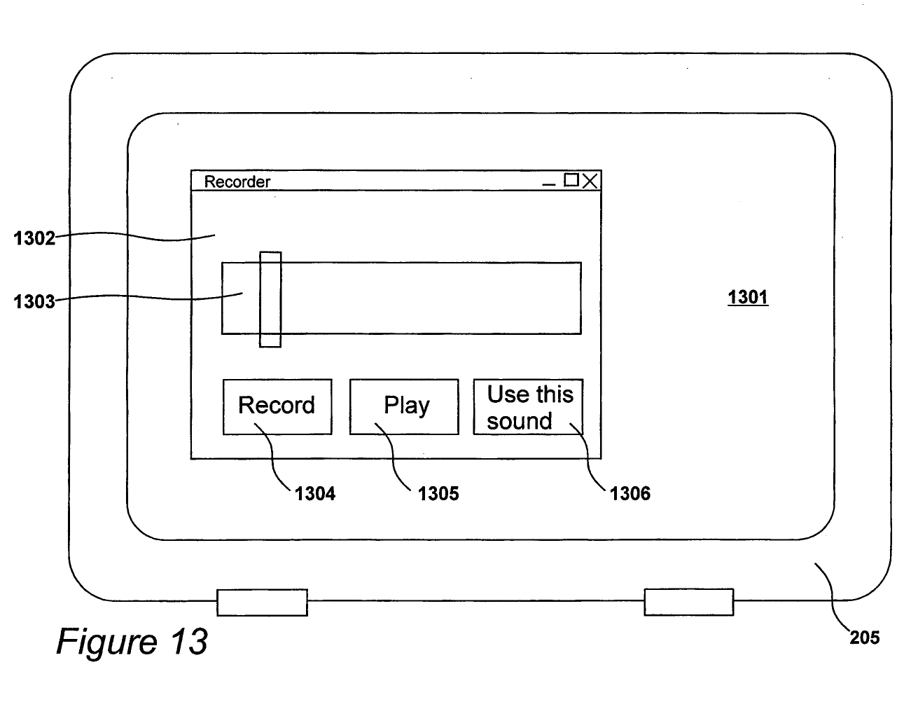

If the question asked at step 604 is answered in the negative indicating user input has not been received choosing to obtain an audio greeting from a file then control passes to step 606. At step 606 a question is asked as to whether the user input has been received choosing to record an audio greeting now. If this question is answered in the affirmative then the greeting is recorded with a microphone at step 607. Step 607 is expanded upon in FIG. 12 and an example is provided in FIG. 13. This concludes step 304.

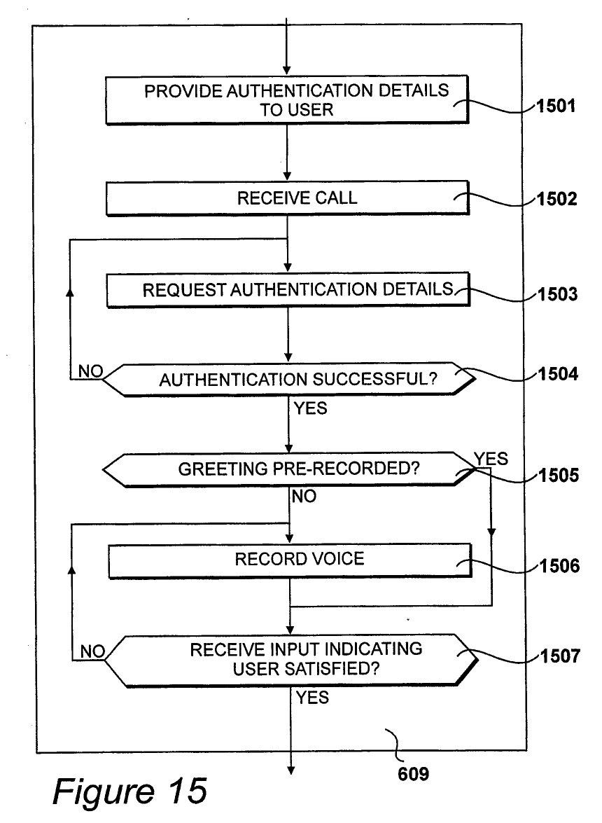

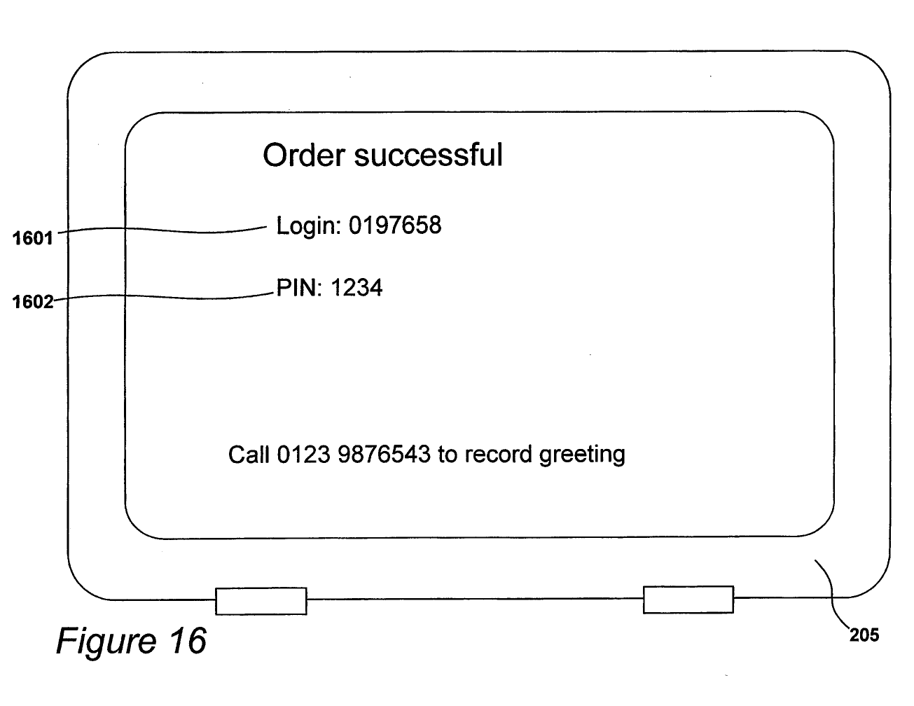

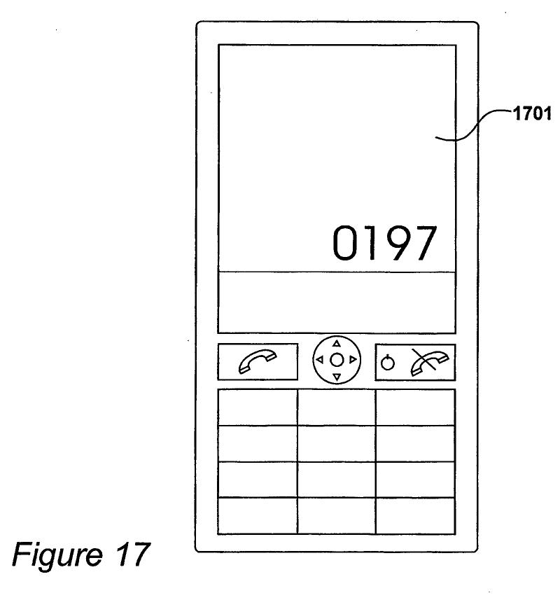

If the question asked at step 606 is answered in the negative indicating that user input has not been received choosing to record now then control passes to step 608. At step 608 a question is asked as to whether user input has been received choosing to record an audio greeting over the telephone. If this question is answered in the affirmative then recording via a telephone connection takes place at step 609. Step 609 is expanded upon in FIG. 15 and further illustrated in FIGS. 16 and 17. The telephone connection used could be a mobile telephone, landline or any other appropriate communicating device. Step 304 is thus concluded.

If the question asked at step 608 is answered in the negative indicating that user input has not been received choosing to record a greeting over the telephone then control passes back to step 601.

### FIG. 7

An example of a screen at which a user is able to identify how they wish to add an audio greeting (step 304) is shown in FIG. 7. Monitor 205 is shown displaying screen 701 which provides four options. Option 702 allows the user to choose a pre-recorded greeting, as described at step 601 of FIG. 6. Option 703 allows a user to choose to add an audio greeting from one of their own files, as described at step 604 of FIG. 6. Option 704 allows a user to record an audio greeting now, using their own computer and microphone. This takes place at step 606 in FIG. 6. Option 705 allows a user to record their greeting later over the telephone as described with reference to step 609 in FIG. 6.

Thus, screen 701 allows a user to choose whether they wish to select audio which is pre-recorded by ticking one of the boxes corresponding with option 702 or 703 or to capture audio which is not pre-recorded by selecting one of options 704 or 705. In alternative embodiments other methods of receiving an audio greeting are also possible. A simplified embodiment could also be provided in which some of the described options are not available.

### FIG. 8

An example of the screen displayed at step 602, where options are presented to a user to add a pre-recorded greeting, is shown in FIG. 8. Monitor 205 displays options for an audio pre-recorded greeting. At 801 a list of types of greeting is provided. The example here includes the greetings “Missing you”, “Happy Birthday (song)”, “Thank you” and “Get Well Soon”. In this embodiment a list is provided but in further embodiments nested menus may be provided whereby a user selects a type of greeting and is able to navigate through a series of menus until they find the greeting they wish to select.

At 802 a user is able to select whether a male or a female voice is chosen to convey their chosen audio greeting. At 803 a user is able to select the accent of the voice which will convey the audio greeting. In this example the accents to chose from are English, French, Italian and Scottish.

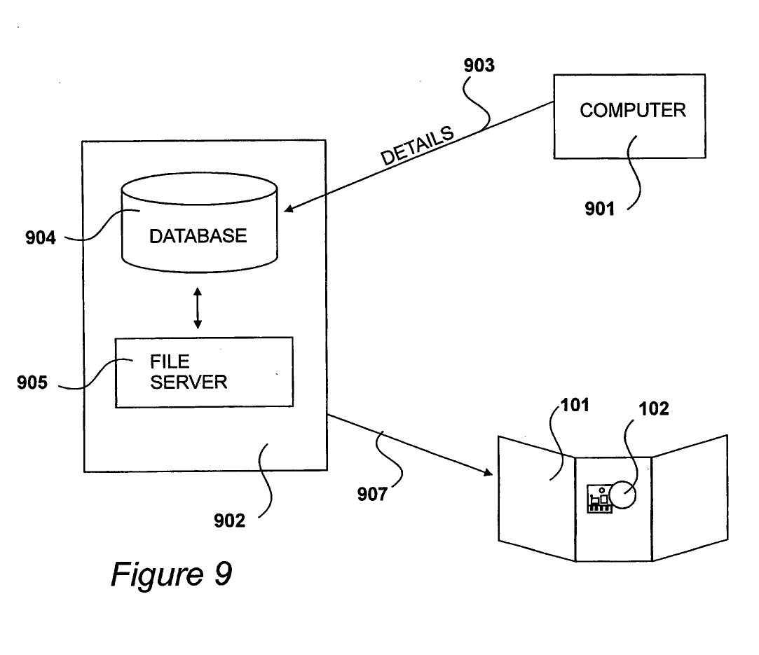

A far wider range of options for greeting, voice, etc can be provided and it should be appreciated that the alternatives shown in FIG. 8 are merely a sample. Further options can include the age of voice, whether the greeting is spoken or sung and how quickly a greeting is said etc. In this embodiment, a finite set of greetings are pre-recorded for a user to choose from and these greetings are stored and retrieved as is described with reference to FIG. 9.

### FIG. 9

A diagram of interactions within the system as a result of selection of the option to add a pre-recorded greeting is shown in FIG. 9. The customer's computer is represented by box 901, which includes the customer's processing system 201. Once the customer's computer 901 has received input identifying the customer details and selecting an audio greeting this information is transmitted to server system 902 as represented by arrow 903. Server system 902, which is embodied as a standard server including storage, memory, processors and at least one network connection, includes a database 904 and a file server 905. Database 904 and file server 905 may or may not exist in the same computer but are part of the same system, and can communicate with each other. Server system 902 may also include further components to fulfil different tasks. The information received from computer 901 to server system 902 is received by database 904 and recorded. Database 904 interacts with file server 905 so that the selected audio greeting is identified. The selected greeting is then downloaded onto module 102 as represented by arrow 907. Module 102 is attached to card 101 and card 101 is then dispatched to the recipient designated at 502 in accordance with the request received.

In this example, where a user has selected a pre-recorded audio greeting the audio greeting will be in an appropriate format for downloading to the item. Thus, no conversion will be required in this case.

### FIG. 10

An example of information displayed at step 605 in FIG. 6 is shown in FIG. 9. This step allows a user to select a file containing an audio greeting.

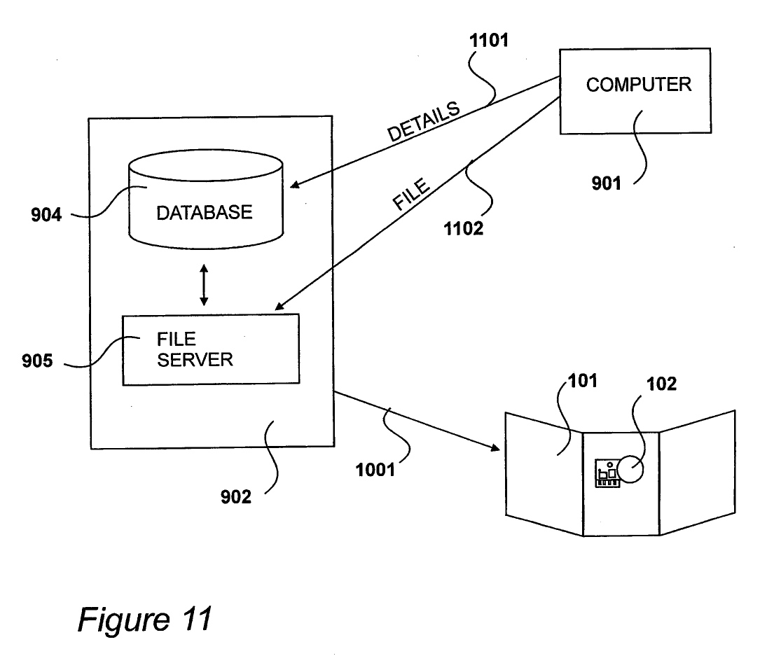

Monitor 205 displays a navigable list of files on the user's own computer and enables the user to select an audio greeting as required. In this example three greetings are presented at 1001, 1002 and 1003 from which a user is able to choose. The system interactions which take place in this example are described with reference to FIG. 11.

### FIG. 11

A diagram of interactions within the system as a result of selection of the option (step 604) to obtain the audio greeting from a file is shown in FIG. 11. The customer's computer 901 is shown. Server system 902 is shown which includes database 904 and a file server 905. Customer computer 901 submits customer details to database 904 as represented by arrow 1101 and customer computer 901 submits a chosen audio file to file server 905 as represented by arrow 1102. In this example, the file selected as described with reference to FIG. 10 may or may not be in an appropriate digital format. If the audio file is not in appropriate format then the server system 902 is able to convert the file such that it is of an appropriate format to be downloaded onto module 102 as represented by arrow 1103. Card 101 can then be printed appropriately, have module 102 attached thereto, and be dispatched in accordance with customer order requirements and details.

### FIG. 12

An expansion of step 607 in FIG. 6 at which an audio greeting is recorded with a microphone is shown in FIG. 12.

At step 1201 a message is displayed to a user prompting them to record their audio greeting. In this embodiment, the audio is recorded by an applet which runs within their internet browser on processing system 201. In alternative embodiments, other configurations can be used and software may be resident on processing system 201 or accessed remotely.

At step 1202 user input is received indicating the start of recording. At step 1203, the audio greeting is recorded. In the present example, the audio greeting can be up to ten seconds in length. In alternative configurations and depending upon the memory capabilities of the item to which the audio greeting is to be added alternative lengths can be used.

Once a greeting has been recorded at 1203, a question is asked at step 1204 as to whether user input has been received requesting playback. If this question is answered in the affirmative then the audio greeting is played back to the user at step 1205. If the question asked at 1204 is answered in the negative indicating that a user does not wish to play back their audio greeting then a question is asked at step 1206 as to whether user input has been received indicating that they wish to use the recorded sound. A user is able to play back and re-record their sound as many times as they wish before deciding whether or not to use it. Hence, if the question asked at 1206 is answered in the negative indicating that the user does not wish to use the recorded sound then control passes back to step 1202 and a user is able to record a further attempt at a greeting. In alternative configurations, there may be a limit to the number of attempts a user is able to have and a counter within the system may calculate whether or not an attempt limit has been exceeded.

When the question asked at 1206 is answered in the affirmative indicating that the recorded sound is to be used then step 607 of recording audio is complete.

### FIG. 13

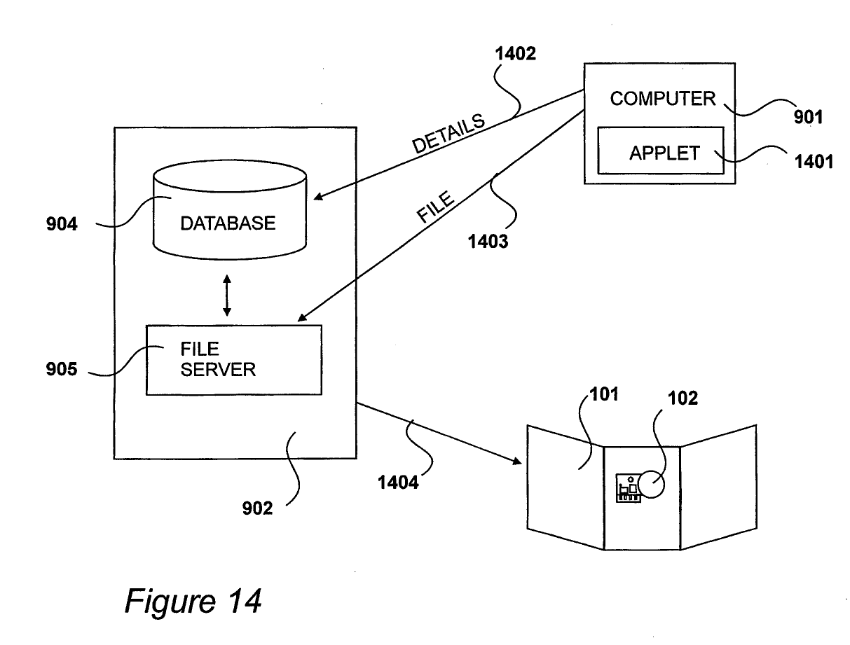

An example of the screen displayed at step 1201 for recording with a microphone is shown in FIG. 12. Monitor 205 is seen displaying screen 1301 that includes display from an applet shown at 1302. In this example the applet is an off-the-shelf sound recording applet, but in alternative embodiments an applet may be designed on a bespoke basis. A progress bar 1303 is provided allowing a user to view how far through their allotted timing they are when recording their audio greeting. In the present embodiment a user does not have slider control over this progress bar although in alternative embodiments they do. A button 1304 is provided to receive user input indicating that they wish to start recording. A further button 1305 is provided which when selected results in the playback of the audio greeting as recorded. A further button 1306 is provided which receives input indicating that a user wishes to proceed with the sound as recorded. Thus, input is received indicating the selection of button 1304 at step 1203, input is received indicating the selection of button 1305 at step 1205 and input is received indicating the selection of button 1306 at step 1206. Communications between the applet shown at 1302 and the rest of the system are described with reference to FIG. 14.

Thus, using the applet as shown in FIG. 13, a user is able to record their chosen audio greeting which can be a combination of them speaking, singing, playing music or making any other sounds. They can play back their greeting as many times as they wish until they are satisfied. At the point at which they are satisfied with the greeting they have recorded they tell the system this by clicking on button 1306 and choosing to use the sound that is recorded.

An advantage of this configuration is that a user is able to control the recording of their greeting themselves and have as many attempts as they wish at achieving the recording as they desire it to sound. In addition, the actions can be carried out from the user's home without the need for them to use any extra equipment which they do not have available to them. The use of an applet means that in this embodiment no extra software needs to be purchased before placing an order.

### FIG. 14

A diagram of interactions within the system as a result of selection of the option (step 607) to record a greeting with a microphone is shown in FIG. 14.

The customer's computer 901 is shown having an applet 1401 or similar program which either runs directly on processing system 201 or is accessed remotely via a network such as the Internet. In this example applet 1401 runs within the Internet browser on the customer's computer. Customer computer 901 submits customer details to database 904 as represented by arrow 1402. In this embodiment, this takes place over a network such as the Internet. Customer computer 901 submits a chosen audio file representing a selected audio greeting recorded by applet 1401 to file server 905 as represented by arrow 1403. In this example, applet 1401 is configured to capture the audio greeting in an appropriate file format such that file server 905 can deal with it appropriately. Therefore conversion of the file is not required in this case. Server system 902 can then download the audio greeting to module 102 as represented by arrow 1404.

### FIG. 15

An expansion of step 609 in FIG. 6 at which an audio greeting is recorded over the telephone is shown in FIG. 15.

In this example, the audio greeting is received via a telephone connection. The customer details and order are still received from a computer in this embodiment although in an alternative embodiment all transactions may take place over a telephone connection. At step 1501 a user is provided with authentication details. In the present embodiment this is a pass code which takes the form of a login code and pin number. The pass code is issued to a user by being displayed on monitor 205 as part of the ordering process. This is further described with reference to FIG. 16.

At step 1502 a call is received from a user. This call is made over a telephone connection which could involve using a mobile telephone, landline telephone etc. At step 1503 a message is played to a user requesting authentication details. In this embodiment, this is a voice message received over the user's phone but in an alternative embodiment this may be received by text message or a further function such as via a wireless application protocol (WAP) functionality etc. A pass code is received from a user as illustrated in FIG. 17 and at step 1504 a question is asked as to whether or not the authentication is successful. At this point a check is performed to ensure that the correct pass code has been submitted. If this question is answered in the negative indicating that authentication has not been successful then control loops back to step 1503 and authentication details are requested again.

If the question asked at step 1504 is answered in the affirmative then a question is asked at step 1505 as to whether a message has already been recorded. It is possible that an audio greeting has been pre-stored on the mobile telephone. If this is the case then the question asked at step 1505 is answered in the affirmative, step 1506 is omitted and the procedures of step 609 are complete.

If the question asked at step 1505 is answered in the negative indicating that audio has not already been recorded then audio is recorded at step 1506. After recording audio it is possible to play back and listen to the greeting that has been recorded, and to continue playing back and re-recording greetings until satisfaction is achieved. In alternative embodiments there is a limit to the number of attempts a user may have and in further alternative embodiments a user may be charged according to the number of attempts they make. Thus at step 1507 a question is asked as to whether a user is satisfied with the recording and if this question is answered in the negative control then passes back to step 1506. If the question asked at step 1507 is answered in the affirmative then procedures performed at step 609 are complete.

### FIG. 16

An example of information displayed at step 1501 at which authentication details are provided is shown in FIG. 16. Monitor 205 is shown displaying authentication details to a user. At 1601 a login code is provided and at 1602 a pin code is displayed. These details form a pass code specific to the user and in alternative embodiments further security questions may be asked. For example a user may be asked to input their date of birth, home telephone number or any other identifier to confirm their authentication.

### FIG. 17

An example of procedures occurring at step 1503 at which a user is requested to provide authentication details is shown in FIG. 17. A mobile telephone 1701 is shown and a user is seen to be submitting their login. When an order is placed at step 302 described with reference to FIG. 3 details of the telephone number to be dialed are provided to a user as shown in FIG. 16. Thus procedures shown in FIG. 17 represent providing authentication details once this number has been dialed and the call is taking place.

An advantage of this system is that users who may not have a microphone facility available to them are able to record their greeting without any specialist equipment. They are able to use a telephone connection to record their greeting and this can be done at any time and from anywhere.

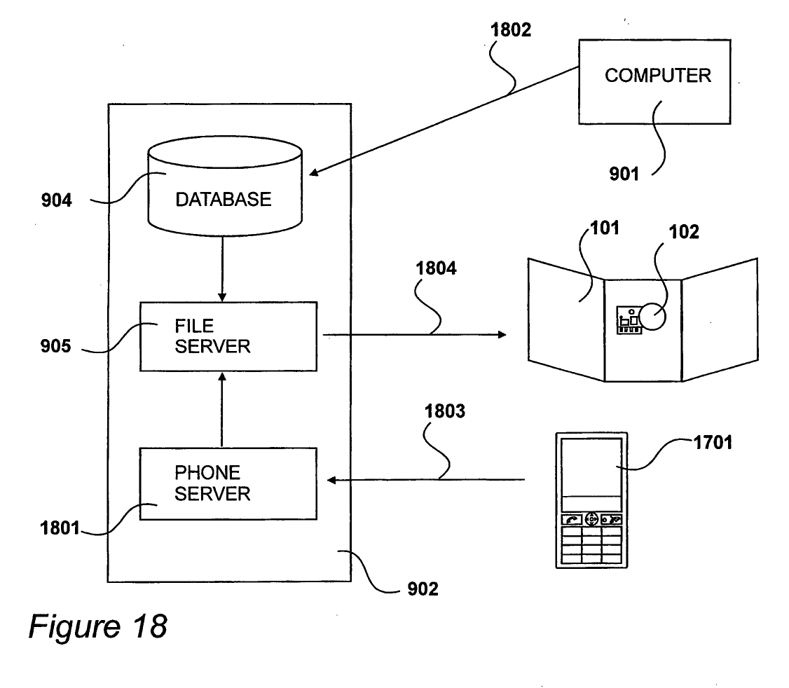

### FIG. 18

A diagram of interactions within the system as a result of selection of the option to record an audio greeting over a telephone connection is shown in FIG. 18.

A customer's computer 901 is shown interacting with server system 902. Server system 902 comprises a database 904, a file server 905 and a phone server 1801. These servers may or may not exist on the same computer but are all parts of the same system. Customer computer 901 submits order information and customer details to database 904 as represented by arrow 1802. Database 904 interacts with file server 905 and in addition phone server 1801 interacts with file server 905.

Audio is received from a telephone such as phone 1701 and this is submitted to phone server 1801 as shown by arrow 1803. Phone server 1801 then deals with any necessary conversion. For example, audio submitted from phone 1701 is likely to be in analog form and so phone server 1801 may, if required, convert the analog greeting in its initial format to a digital file in transfer format before submitting it to file server 1904. The system can be configured to deal with any other combination of conversions between file or data types. File server 905 is then used to download the audio greeting onto module 102 as represented by arrow 1804. Module 102 is then attached to card 101 and it is dispatched to the recipient.

### FIG. 19

Card 101 is shown being prepared for dispatch in FIG. 19. Module 102 has been attached inside card 101, and if a greeting was entered at 507 then this has been printed inside card 101.

Card 101 is shown being placed into envelope 1901. Envelope 1901 is pre-printed with recipient's name and address as provided at 502 and 503 in FIG. 5.

### FIG. 20

An example of a collection of cards ready for dispatch is shown in FIG. 20. Envelope 1901 is shown which contains card 101. Further envelopes 2001 and 2002 also containing cards are shown. Dispatch can be co-ordinated such that card 101 is received by the recipient on an appropriate date in accordance with the event date entered at 506 and as described with reference to FIG. 5.

Envelopes 1901, 2001, 2002 are dispatched to their recipients via a postal service, which could be standard mail, courier etc. Thus, the recipient receives an item which conveys an audio greeting.

1. A method of producing an item for conveying an audio greeting comprising the steps of:
receiving a request for dispatching an item to a recipient;
receiving an audio greeting via a telephone connection;
requiring a pass code to be submitted via said telephone connection;
checking that the correct pass code has been submitted before receiving said audio greeting via said telephone connection;
downloading said audio greeting to said item; and
dispatching said item to said recipient.

2. A method according to claim 1, wherein said item is a greetings card that includes an audio playback device.

3. A method according to claim 1, wherein said request is received from a computer.

4. A method according to claim 1, wherein said audio greeting is received in an initial format and converted into a transfer format before being downloaded.

5. A method according to claim 4, wherein said conversion is analog to digital.

6. A method according to claim 4, wherein said conversion is digital to analog.

7. A method according claim 1, wherein said audio greeting is downloaded onto said item in a transfer format and stored on said item in a storage format.

8. A method according to claim 1, wherein said item is dispatched to said recipient via a postal service.

9. A method according to claim 1, further including the step of issuing a pass code in response to said request.

10. A method of producing an item for conveying an audio greeting comprising the steps of:
receiving a request for dispatching an item to a recipient;
receiving an indication as to whether a pre-recorded or new audio greeting is required;
if a pre-recorded greeting is required, receiving a selection from a set of pre-recorded greetings, and
if a new audio greeting is required, receiving an audio greeting;
downloading said audio greeting to said item; and
dispatching said item to said recipient.

11. A method according to claim 1, wherein said item is a greetings card that includes an audio playback device.

12. A method according to claim 1, wherein if a new audio greeting is required, said request is received from a computer.

13. A method according to claim 1, wherein if a new audio greeting is required, said audio greeting is received from a computer.

14. A method according to claim 13, wherein said audio greeting is received from said computer via the Internet.

15. A method according to claim 1, wherein if a new audio greeting is required, said audio greeting is received via a telephone connection.

16. A method according to claim 15, further comprising the steps of:
issuing a pass code in response to said request;
requiring said pass code to be submitted via said telephone connection; and
checking that the correct pass code has been submitted before receiving said audio greeting via said telephone connection.

17. A method according to claim 1, wherein said audio greeting is received in an initial format and converted into a transfer format before being downloaded.

18. A method according to claim 17, wherein said conversion is analog to digital.

19. A method according to claim 17, wherein said conversion is digital to analog.

20. A method according to claim 1, wherein said audio greeting is downloaded onto said item in a transfer format and stored on said item in a storage format.

21. A method according to claim 1, wherein said item is dispatched to said recipient via a postal service.

22. A method according to claim 11, wherein said set of pre-recorded greetings includes a plurality of greetings comprising the same words said in different voices.

23. Apparatus for producing an item for conveying an audio greeting, comprising storage, memory, a processor and a network connection, wherein said processor is configured to perform the steps of:
receiving a request, via said network connection, for dispatching an item to a recipient;
receiving an audio greeting;
downloading said audio greeting to said item; and
dispatching said item to said recipient.

24. Apparatus according to claim 23, wherein said item is a greetings card that includes an audio playback device.

25. Apparatus according to claim 23, wherein said request is received from a network-connected computer.

26. Apparatus according to claim 23, wherein said audio greeting is received from a network-connected computer.

27. Apparatus according to claim 23, wherein said audio greeting is received via a telephone connection.

28. Apparatus according to claim 27, wherein said processor is further configured to:
issue a pass code in response to said request;
require said pass code to be submitted via said telephone connection; and
check that the correct pass code has been submitted before receiving said audio greeting via said telephone connection.

29. Apparatus according to claim 23, wherein said audio greeting is received in an initial format and said processor is further configured to convert said audio greeting into a transfer format before downloading it.

30. Apparatus according to claim 23, wherein said processor is configured to download said audio greeting onto said item in a transfer format and store it on said item in a storage format.

31. Apparatus according to claim 23, wherein said item is dispatched to said recipient via a postal service.

32. Apparatus according to claim 23, wherein said audio greeting is selected from a collection of pre-recorded greetings.
